(19) United States
(12) Patent Application Publication
(10) Pub. No.: US 2022/0221566 A1
(43) Pub. Date: Jul. 14, 2022

(54) ON-CHIP BACK REFLECTION FILTERING

(71) Applicant: Intel Corporation, Santa Clara, CA (US)

(72) Inventors: Jin Hong, Saratoga, CA (US); Jianying Zhou, Dublin, CA (US); Sanjeev Gupta, Santa Rosa, CA (US); Syed S. Islam, Cupertino, CA (US); Christian Malouin, San Jose, CA (US)

(73) Assignee: Intel Corporation, Santa Clara, CA (US)

(21) Appl. No.: 17/707,882

(22) Filed: Mar. 29, 2022

(51) Int. Cl. G01S 7/4913; G01S 7/481

(52) U.S. Cl. CPC G01S 7/4913; G01S 7/4811

(57) ABSTRACT

Filter circuitry is provided for use with a light detection and ranging (Lidar) device implemented using silicon photonics. The filter circuitry includes high-pass filter circuitry to receive a signal from a photodetector of the lidar device and attenuate a lower frequency portion of the signal, where the lower frequency portion of the signal is the result of optical back reflections within the lidar device.

### FIELD

This disclosure pertains to computing systems, and in particular (but not exclusively) to Lidar systems.

### BACKGROUND

Advances in semi-conductor processing and logic design have permitted an increase in the amount of logic that may be present on integrated circuit devices. As a corollary, computer system configurations have evolved from a single or multiple integrated circuits in a system to multiple cores, multiple hardware threads, and multiple logical processors present on individual integrated circuits, as well as other interfaces integrated within such processors. A processor or integrated circuit typically comprises a single physical processor die, where the processor die may include any number of cores, hardware threads, logical processors, interfaces, memory, controller hubs, etc.

There is also an increasing demand for three dimensional (3D) video or image capture, as well as increasing demand for object tracking or object scanning. Thus, the interest in 3D imaging is not simply to sense direction, but also depth. Longer wavelength signals (such as radar) have wavelengths that are too long to provide the sub-millimeter resolution required for smaller objects and for recognition of finger gestures and facial expressions. Such imaging techniques may be useful in a variety of applications, including autonomous vehicles, robotics, and computer images. Some systems may be based on light detection and ranging (“LiDAR”, “LIDAR”, “Lidar”, or “Lidar”) technologies, which use optical wavelengths, and can provide finer resolution. A basic Lidar system includes one or more light sources and photodetectors, a means of either projecting or scanning the light beam(s) over the scene of interest, and one or more control systems to process and interpret the data. Scanning or steering the light beam traditionally relies on precision mechanical parts, which are expensive to manufacture, and are bulky and consume a lot of power.

### BRIEF DESCRIPTION OF THE DRAWINGS

FIG. 1 is a block diagram of an embodiment of a system with an integrated solid state Lidar circuit.

FIG. 2 is a block diagram illustrating operation of an example Lidar circuit.

FIG. 3 is a block diagram illustrating example circuitry of an example Lidar system.

FIGS. 4A-4B are graphs illustrating the effect of a high-pass filter in an example Lidar system.

FIG. 5 is a graph illustrating thermal noise within an example Lidar system.

FIG. 6 is a block diagram illustrating example circuitry in another example of a Lidar system.

FIG. 7 is a block diagram illustrating a first embodiment of an example Lidar system.

FIG. 8 is a block diagram illustrating a second embodiment of an example Lidar system.

FIG. 9 is a block diagram illustrating a third embodiment of an example Lidar system.

FIG. 10 illustrates an embodiment of a block diagram for a computing system including a multicore processor.

FIG. 11 illustrates an embodiment of a block for a computing system including multiple processors.

### DETAILED DESCRIPTION

In the following description, numerous specific details are set forth, such as examples of specific types of processors and system configurations, specific hardware structures, specific architectural and micro architectural details, specific register configurations, specific instruction types, specific system components, specific measurements/heights, specific processor pipeline stages and operation etc. in order to provide a thorough understanding of the present disclosure. It will be apparent, however, to one skilled in the art that these specific details need not be employed to practice the solutions provided in the present disclosure. In other instances, well known components or methods, such as specific and alternative processor architectures, specific logic circuits/code for described algorithms, specific firmware code, specific interconnect operation, specific logic configurations, specific manufacturing techniques and materials, specific compiler implementations, specific expression of algorithms in code, specific power down and gating techniques/logic and other specific operational details of computer system have not been described in detail in order to avoid unnecessarily obscuring the present disclosure.

A basic Lidar system may include one or more laser sources and photodetectors, a means of scanning the beam(s) over the scene of interest or the target, and control logic to process the observed data. In one embodiment, the use of photonics processing extended with LC or LCOS processing can enable the integration of a Lidar engine on a single chip, compatible with wafer-scale manufacturing technologies. The light sources and detectors (e.g., lasers and photodetectors (PDs)) can be created on the same chip, or coupled to the solid state Lidar engine.

It will be understood that there are different types of Lidar, including time-of-flight (TOF) and frequency modulated continuous wave (FMCW). TOF Lidar relies on measuring the time delay between a transmitted pulse and a received pulse, and is therefore suitable for long range applications. For shorter range applications, high speed electronics provide better imaging. In FMCW systems, the laser wavelength can be scanned in a sawtooth waveform. The reflected beam is received and interfered with the reference beam in the Lidar system (the Lidar engine and detectors). The beat signal gives the frequency difference between the 2 beams, which can be converted to time and thus distance of the object.

To complete a Lidar system, a Lidar engine that generates steerable light is combined with one or more photodetectors to receive the reflected light. In one embodiment, a detector is integrated with the Lidar engine circuit. In one embodiment, a laser is also integrated with the Lidar engine circuit. The detector can be a discrete photodetector or a hybrid photodetector made in the same process as a hybrid laser, which can be made as part of the semiconductor photonics processing. The architecture of the receiver depends on the type of Lidar (e.g., TOF or FMCW). A signal may be generated by the photodetector to describe or indicate the characteristics of the object from which the list is reflected and this signal may be further processed by processing logic implemented in hardware and/or software.

In one embodiment, a Lidar circuit or device may be implemented using solid state photonics circuits, such as circuits including an array of waveguides disposed in either a semiconductor or an insulator, and a means of phase tuning the optical signals in the waveguides in order to steer the recombined beam. In some implementations, the phase steering mechanism can be thermooptic, in which electrical heating elements incorporated near the waveguides are used to change the optical phase of the signals, or electrooptic in which an applied voltage is used to change the phase or absorption of the optical mode through the well-known Franz Keldysh effect or the well-known Quantum Confined Stark Effect, or electrooptic in which a diode or capacitor incorporated into the waveguide is used to alter either the concentration of electrical charge interacting with the optical mode, thus altering the phase through the well-known effect of plasma dispersion, or using a liquid crystal (LC) layer (which can specifically be liquid crystal on silicon (LCOS) when silicon photonics are used) selectively adjacent to the waveguides. The waveguides have an adjacent insulating layer (e.g., oxide), where the insulating layer has an opening to expose the array of waveguides to the LC layer. The LC layer can provide tuning for the array of waveguides by controlling the application of voltage to the liquid crystal. The voltage applied to the LC layer can separately tune all the waveguides. Applying different voltages to the LC layer can create phase shifts to steer the beam of laser light passing through the waveguides. In one embodiment, the opening in the insulator exposes more or less of different waveguides to produce a different phase shifting effect for each different waveguide.

It will be understood that LCOS beamsteering is only one example of a possible semiconductor steering mechanism that can be used in a solid state Lidar as referred to herein. In one embodiment, a Lidar system in accordance with what is described herein includes LC-based beamsteering. In one embodiment, a Lidar system in accordance with what is described herein includes a thermo-optic phase array. A thermo-optic phase array is an array of waveguides with resistive heaters placed in proximity of the waveguides. Control logic applies a current to the resistive heaters to create more or less heat. Based on the change in temperature, the phase of signals in the waveguides will vary. Control over the heating can control the phase of the signals and steer the beam.

In one embodiment, a Lidar system in accordance with what is described herein includes an electro-optic phase array. An electro-optic phase array refers to an array of waveguides integrated with electrodes for application of either current or voltage to enable phase control via electro-optic deflection or modulation. Based on changing voltage or current levels, the material's electro-optical properties cause a change in transmission of the optical signal through the waveguides based on changes to one or more applied voltages or currents. Thus, control of the voltage or current can control phase of the signals in the waveguides and steer the beam. A Lidar system can thus provide a steerable laser via electro-optical modulation, thermo-optical phase adjustment, liquid crystal beamsteering, or other beamsteering mechanism that can be integrated with a waveguide array on a Lidar integrated circuit.

The use of solid state photonics allows the integration of photonics components in a semiconductor substrate (e.g., silicon-based photonics in a silicon substrate, and/or III-V based photonic elements integrated with a silicon substrate). The photonics components can include waveguides and combiners for routing light, passive elements that enable phased arrays for beam forming, one or more couplers to redirect light perpendicular to the photonics substrate, and can include lasers, modulators, and/or detectors. In one embodiment, the semiconductor photonics is silicon based, which allows the use of a standard silicon photonic transmitter wafer. In one embodiment, the silicon photonics processing incorporates III-V elements (e.g. Indium phosphide or Gallium Arsenide) integrated with the silicon for purposes of lasing, amplification, modulation, or detection. In one embodiment, the standard silicon photonics processing is extended to process liquid crystal onto the silicon photonics. The LC enables a voltage-dependent change in the refractive index, which can enable both x and y beamsteering or beamforming. Again, other forms of integrated phase control could alternatively be used, such as thermo-optic phase control or electro-optic phase control.

A basic Lidar system includes one or more laser sources and photodetectors, a means of scanning the beam(s) over the scene of interest or the target, and control logic to process the observed data. In one embodiment, the use of photonics processing extended with an integrated phase control mechanism can enable the integration of a Lidar engine on a single chip, compatible with wafer-scale manufacturing technologies. The light sources and detectors (e.g., lasers and photodetectors (PDs)) can be created on the same chip, or coupled to the solid state Lidar engine. In either case, the solid state Lidar engine provides a Lidar engine with no moving parts, and which can be manufactured at much lower cost than traditional Lidar engines. Additionally, the use of semiconductor processing techniques allows the device to be low power and to have a much smaller form factor than traditionally available. Additionally, the resulting Lidar circuit does not need the traditional precision mechanical parts, which not only increase costs, but suffer from vibration and other environmental disturbances. Furthermore, the solid state Lidar would not require hermetic sealing on the packaging, which is traditionally necessary to avoid dust and humidity from clogging the mechanics of the Lidar system.

Reductions in power and size combined with improvements in reliability (reduced sensitivity to environmental factors) can increase the applications of 3D imaging. 3D imaging with a solid state Lidar can improve functionality for gaming and image recognition. Additionally, 3D imaging can be more robust for applications in replication of objects for 3D printing, indoor mapping for architecture or interior design, autonomous driving or other autonomous robotic movements, improved biometric imaging, and other applications. In one embodiment, the solid state Lidar described herein can be combined with inertial measurement circuits or units to allow high resolution 3D imaging of a scene. Such a combined device would significantly improve on the low resolution of conventional Lidar system. The low resolution of traditional Lidar system is due to raster scanning a discrete series of point, which degrades spatial resolution.

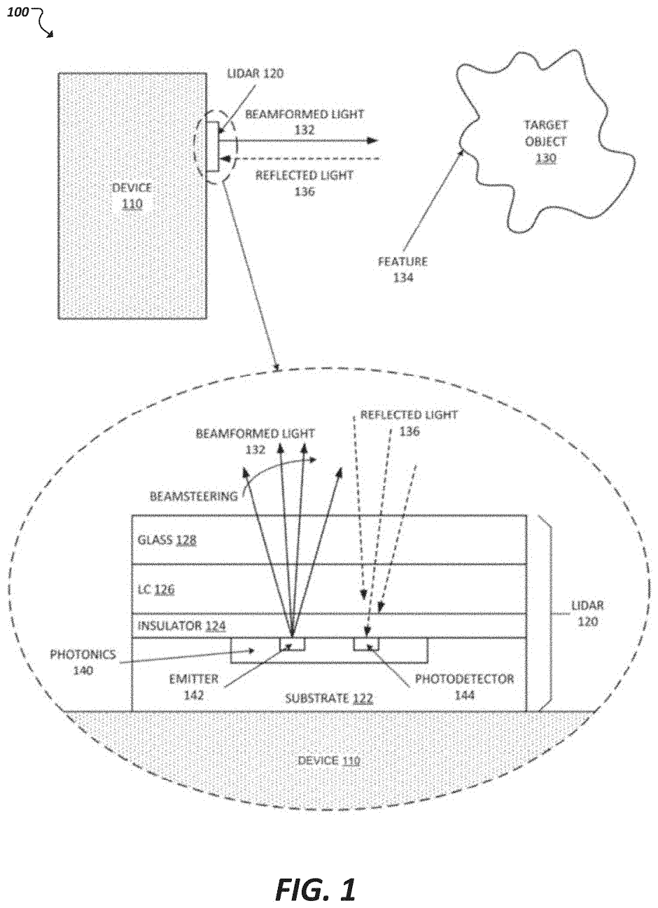

FIG. 1 is a block diagram of an embodiment of a system with an integrated solid state Lidar circuit. System 100 represents any system in which a solid state Lidar that provides solid state beamsteering and applies modulation can be used to provide 3D imaging. The solid state Lidar can be referred to as a Lidar engine circuit or Lidar circuit. Device 110 includes Lidar 120 to perform imaging of target object 130. Target object 130 can be any object or scene (e.g., object against a background, or group of objects) to be imaged. Device 110 generate a 3D image of object 130 by sending beamformed light 132 (a light signal) and processing reflections from the light signal.

Object 130 can represent an inanimate object, a person, a hand, a face, or other object. Object 130 includes feature 134, which represents a feature, contour, protrusion, depression, or other three dimensional aspect of the object that can be identified with sufficient precision of depth perception. Reflected light 136 represents an echo or reflection that scatters off target object 130 and returns to Lidar 120. The reflection enables Lidar 120 to perform detection.

Device 110 represents any computing device, handheld electronic device, stationary device, gaming system, print system, robotic system, camera equipment, or other type of device that could use 3D imaging. Device 110 can have Lidar 120 integrated into device 110 (e.g., Lidar 120 is integrated onto a common semiconductor substrate as electronics of device 110), or mounted or disposed on or in device 110. Lidar 120 can be a circuit and/or a standalone device. Lidar 120 produces beamformed light 132. In one embodiment, Lidar 120 also processes data collected from reflected light 136.

System 100 illustrates a close-up of one embodiment of Lidar 120 in the rotated inset. Traditional Lidar implementations require mechanical parts to steer generated light. Lidar 120 can steer light without moving parts. It will be understood that the dimensions of elements illustrated in the inset are not necessarily to scale. Lidar 120 includes substrate 122, which is a silicon substrate or other substrate in or on which photonics or photonic circuit elements 140 are integrated. In one embodiment, substrate 122 is a silicon-based substrate. In one embodiment, substrate 122 is a III-V substrate. In one embodiment, substrate 122 is an insulator substrate. Photonics 140 include at least an array of waveguides to convey light from a source (e.g., a laser, not specifically shown) to a coupler that can output the light as beamformed light 132.

The inset specifically illustrates liquid crystal beamsteering capability in Lidar 120. It will be understood that alternative embodiments of Lidar 120 can include integrated thermo-optic phase control components or electro-optic phase control components in photonic circuit elements 140. While not specifically shown in system 100, it will be understood that such applications represent an embodiment of system 100. Referring more specifically to the illustration, insulator 124 includes an opening (not seen in system 100) over an array of waveguides and/or other photonics 140 to selectively provide an interface between photonics 140 and LC 126. In one embodiment, insulator 124 is an oxide layer (any of a number of different oxide materials). In one embodiment, insulator 124 can be a nitride layer. In one embodiment, insulator 124 can be another dielectric material. LC 126 can change a refractive index of waveguides in photonics 140. The opening in insulator 124 can introduce differences in phase in the various light paths of the array of waveguides, which will cause multiple differently-phased light signals to be generated from a single light source. In one embodiment, the opening in insulator 124 is shaped to introduce a phase ramp across the various waveguides in the array of waveguides in photonics 140.

It will be understood that the shape in insulator 124 can change how much of each waveguide path is exposed to LC 126. Thus, application of a single voltage level to LC 126 can result in different phase effects at all the waveguide paths. Such an approach is contrasted to traditional methods of having different logic elements for each different waveguides to cause phase changes across the waveguide array. Differences in the single voltage applied to LC 126 (e.g., apply one voltage level for a period of time, and then apply a different voltage level) can dynamically change and steer the light emitted from Lidar 120. Thus, Lidar 120 can steer the light emitted by changing the application of a voltage to the LCOS, which can in turn change the phase effects that occur on each waveguide path. Thus, Lidar 120 can steer the light beam without the use of mechanical parts. Beamformed light 132 passes through insulator 124, LC 126, and a capping layer such as glass 128. The glass layer is an example only, and may be replaceable by a plastic material or other material that is optically transparent at the wavelength(s) of interest. The arrows representing beamformed light 132 in the inset are meant to illustrate that the phases of the light can be changed to achieve a beam forming or steering effect on the light without having to mechanically direct the light.

In one embodiment, photonics 140 include an optical emitter circuit 142, which transfers light from waveguides within photonics towards target object 130 as beamformed light 132. In one embodiment, photonics 140 include a modulator to modulate a known bit sequence or bit pattern onto the optical signal that is emitted as beamformed light 132. In one embodiment, photonics 140 include one or more photodetectors 144 to receive reflected light 136. Photodetector 144 and photonics 140 convey received light to one or more processing elements for autocorrelation with the modulated bit sequence.

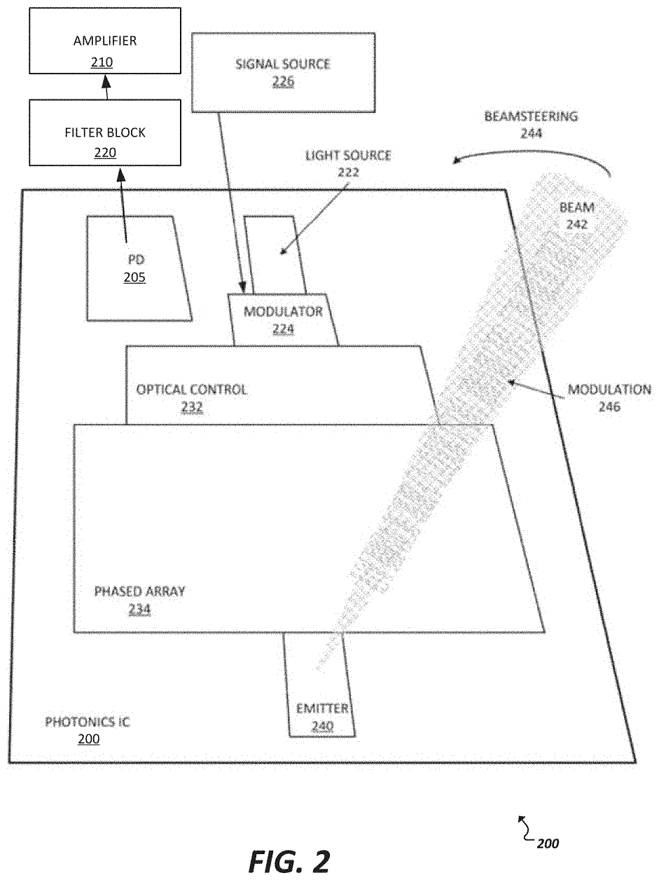

FIG. 2 is a block diagram of an embodiment of a system with an integrated solid state Lidar circuit that includes filtering circuitry (e.g., 220) and amplifier circuitry (e.g., 210) to improve the quality of results and corresponding signals generated by a solid state Lidar device. System 200 provides one example of a Lidar system in accordance with an embodiment of system 100. System 200 is illustrated in a format that might approximate an embodiment of an optical chip based on silicon photonics. It will be understood that components are not necessarily shown to scale, or shown in a practical layout. The illustration of system 200 is to provide one example of a Lidar as described herein, without necessarily illustrating layout details.

Photonics IC (integrated circuit) represents a chip and/or circuit board on which photonics components are disposed. At a silicon-processing level, each component disposed on photonics IC 200 can be integrated via optical processing techniques to create active components (such as drivers, lasers, processors, amplifiers, and other components) and passive components (such as waveguides, mirrors, gratings, couplers, and other components). Other components are possible. At another level, photonics IC 200 may be a system on a chip (SoC) substrate, with one or more components integrated directly onto the substrate, and one or more components disposed as separate ICs onto the SoC. At a circuit board level, photonics IC 200 could actually be a PCB (printed circuit board) onto which discrete components (such as a laser and a coupler) are disposed in addition to a core Lidar engine IC enabled to generate a steerable light source.

In one embodiment, photonics IC 200 includes light source 222, such as a laser. In one embodiment, light source 222 includes an off-chip laser. In one embodiment, light source 222 includes an integrated on-chip laser. An on-chip laser can be made, for example, from III-V semiconductor material bonded to a silicon-on-insulator chip substrate, with waveguides integrated in the silicon layer and gain provided by the III-V materials. Light source 222 passes an optical signal through modulator 224, which modulates a signal onto the optical carrier. Modulator 224 can be a high speed modulator. In one embodiment, modulator 224 can be a Mach-Zehnder modulator using either carrier depletion, carrier injection, or an applied electrical field to apply phase tuning to the two arms of an interferometer, thus creating constructive and destructive interference between the optical beams propagating in the two arms to induce amplitude modulation. In another embodiment, modulator 224 can be an electro-absorption modulator using carrier injection, carrier depletion, or an applied electrical field to cause absorption of the optical beam and thus induce amplitude modulation. In one embodiment, modulator 224 can be embodied in a silicon layer of system 200. In one embodiment where system 200 includes III-V material, modulator 224 can be integrated into the III-V material or both in silicon and III-V. The modulated signal will enable system 200 to autocorrelate reflection signals to perform depth detection of an object and/or environment. In one embodiment, signal source 226 represents an off-chip source of the bit pattern signal to be modulated onto the optical signal. In one embodiment, signal source 226 can be integrated onto photonics IC 200.

In one embodiment, modulator 224 passes the modulated optical signal to optical control 232. Optical control 232 represents elements within photonics IC 200 to can amplify, couple, select, and/or otherwise direct optical power via a waveguide to the phased array for phase control. Phased array 234 represents components on photonics IC 200 to apply variable phase control to separated optical signals to enable beamsteering by photonics IC 200. Thus, photonics IC 200 combines optical signal modulation with a Lidar engine that generates steerable light. Emitter 240 represents an emitter mechanism, such as a grating coupler or other coupler that emits light off-chip from the on-chip waveguides.

Beam 242 represents a light beam generated by photonics IC 200. Beamsteering 244 represents how photonics IC 200 can steer beam 242 in x-y coordinates with respect to a plane of the surface of photonics IC 200 on which the components are disposed. While not necessarily to scale or representative of a practical signal, beam 242 is illustrated as being overlaid with modulation 246 to represent the modulation generated by modulator 224. Phase array 234 can include optical components and/or features to phase-offset a modulated optical signal split among various waveguides, with each phase-delayed version of the optical signal to be transmitted in turn, based on the delay. The delays introduced can operate to steer beam 242. In one embodiment, modulation 246 is a 20 Gb/s signal generated by modulator 224 to impress a long-code bit pattern sequence onto beam 242. In one embodiment, modulator 224 generates a 2 Gb/s signal. It will be understood that generally a higher modulation speed may further improve SNR, among other examples.

To be a complete Lidar system, system 200 includes one or more detectors to capture reflections of beam 242. In one embodiment, PD 205 represents a detector integrated with the Lidar engine circuit. It will be understood that PD 205 can be on a separate chip from the beamsteering optics. Similarly, while photonics IC 200 is illustrated having integrated light source 222, a laser could be on a chip separate from the beamsteering optics. In one embodiment, PD 205 receives light from a reverse path of waveguides used to transmit beam 242. In one embodiment, PD 205 has a separate received light path.

PD 205 can be or include a high bandwidth photodiode and one or more amplifier circuits. PD 205 receives light reflected back from one or more objects targeted by the laser emitter 240 and generates a signal corresponding to the reflections. Undesirable optical back reflections may also be received by the PD 205 and incorporated as noise within the signal. The signal generated by the PD 205 may be passed to one or more filter blocks (e.g., 220) to remove such noise from the signal prior to the signal being amplified (e.g., for later consumption by one or more compute units (not shown)) by one or more amplified blocks (e.g., 210).

In one embodiment, a laser (e.g., light source 222), amplifier, modulator (e.g., 224), and/or detector (e.g., PD 205), or any combination thereof may be integrated on silicon using III-V material (e.g. Indium Phosphide based semiconductor incorporating various compatible quaternary or ternary compounds to act as quantum wells, contact layers, confinement layers, or carrier blocking layers). Such III-V components can be attached to the silicon or to an intermediate layer. In an embodiment using III-V material, the III-V material can provide gain, modulation, and/or absorption for optical modes which propagate through the silicon. Thus, III-V material can be used to integrate a laser, an amplifier, a modulator, and/or a photodetector on-chip.

Frequency modulation continuous wave (FMCW) Lidar is very attractive for advanced Lidar applications such as in autonomous vehicles, robots, drones, and other machines capable of being autonomously moved within an environment based on their detected surroundings. Accordingly, embodiments of passenger and/or cargo vehicles, including land-, water-, and air-based vehicles, may be equipped with Lidar sensors to facilitate the “vision” of the vehicle's control system used to autonomously or semi-autonomously navigate an environment. In some implementations, such Lidar devices may be implemented as Lidar chips, or other devices implemented on silicon (e.g., using silicon photonics and other technologies). In some instances, silicon-based Lidar sensors may be vulnerable to interference created by on-chip back reflections. Such vulnerabilities may limit traditional Lidar devices from being deployed in security-sensitive application such as autonomous transportation. Indeed, on-chip optical back reflections can be serious issues for integrated coherent Lidar receivers and Lidar systems, especially for the LiDAR chip based on silicon photonics technology where hundreds of optical elements and devices are integrated together to form the basic core functions of coherent LiDAR. Even with the state of the art of silicon photonics fabrication process, the optical back reflections, originated from the scattering in many different areas of device transitions on the silicon photonics chips, including the ones from various tapering sections, discontinuous waveguide structures, and the output optical terminating facet may still be limited (e.g. to −35 dB or higher). Further, the noise due to those on-chip back reflections can be much higher than the detected range signal. The detected signal reflected from the remote target suffers through high atmospheric attenuation and scattering loss, compared to the OBR which has less loss. As a result, the OBR could cause the saturation of amplifiers used in Lidar coherent receivers, and therefore could potentially cause serious performance issues in coherent Lidar system. This could pose as a one of the biggest and most challenging problems yet to be resolved for the silicon photonics coherent Lidar systems to become commercially viable over the next decade, among other example issues.

Applications of Lidar, such as autonomous vehicle or robot navigation, may be intolerant to the effects of on-chip back reflection (OBR). Traditional Lidar chips may utilize a balanced photodetector (PD) and amplifier configuration (e.g., the amplifier provided to amplify the signals generated by the photodetector from the relatively low amplitude reflections received by the Lidar device). The amplifier(s) may also enhance back reflections and interfere with the useful signals generated in the device. Accordingly, some applications may call for back reflection less than −50 dB or much lower, which may not be achievable even with the most state-of-the-art silicon photonics design and fabrication process for coherent Lidar chip in the volume production environment. Additionally, it severely limits the design range of both the photonic chip and the associated amplifier circuitry, and therefore the overall Lidar system performance.

In improved implementations of a silicon-based Lidar device, high-pass filter circuitry may be included in the Lidar system to address the effects of on-chip back reflections among other example issues, such as those introduced in the examples above. For instance, a high pass filter may be positioned between the output of a balanced photodetector and the initial input stage of associated amplified circuitry. In some implementations, such high pass filter circuitry can achieve greater than 20 dB more isolation to filter out the noise due to on-chip back reflection. The design can maintain the required min target range (e.g., 0.5 meter or less), but allow the required back reflection limits to be 20 dB higher than those in traditional configurations (e.g., a conventional balanced PD and amplifier configuration). Likewise, the provision of one or more such filtering stages may achieve much better overall performance and Lidar system performance through the elimination of the penalty caused by the on-chip and back reflection into the balanced photodetector, even in systems with the comparable levels of back reflection. Such improvements may allow back reflection limit requirements to be loosened (e.g., by an increase of 20 dB of more) and allow lower cost and higher yielding silicon photonics fabrication processes to be effectively utilized to produce commercially viable integrated Lidar coherent receivers (e.g., with similar range capabilities (e.g., 0.5-200 m, etc.). Such improved systems may further eliminate the impact of less ideal common mode rejection ration (CMRR) with electrical current sink termination, which may not be feasible in conventional PD-amplifier configurations with the conventional PD and TIA configurations, among other example benefits.

As introduced above, FMCW Lidar is a promising technology attractive for advanced Lidar applications such as in autonomous navigation with advantages including cost-effective implementation, ability to detect both distance and speed of the object, robustness to background noises and interference over conventional time-of-flight and direct detection Lidar. The development of integrated photonics chips (“PIC”) has promised to have low cost and compact size for FMCW implementations. However, on-chip optical back reflection present in optical path of such devices threaten the performance of such devices, given the back-reflections emanating from the multiple cascaded components and multiple channels including optical splitters, tapers, couplers, lasers, modulators, semiconductor optical amplifiers and optical input and output, etc. present on PIC devices. For example, on-chip optical back reflection (OBR) at the device facet may be greater than −35 dB. The noise due to OBR, which is coupled into the photodetector, can cause the saturation of amplification circuits used in or with PIC devices. In order to detect the signal over a wide range, the Lidar system may require on-chip OBR to be less than a threshold value (e.g., less than −50 dB), which may be challenging to realize, even with state-of-art silicon photonics design and fabrication processes.

In some implementations, an improved Lidar system may be provided that includes a Lidar sensor implemented on an integrated silicon photonics device and that includes one or more high-pass filter (HPF) blocks between the photodetector and an amplifier stage to remove noise from on-chip OBR. In some implementations, the HPF block may be provided separate from the amplifier and/or photodetector. In other implementations, the HPF circuitry may be provided at least in part (e.g., as a first of multiple filtering stages) on the amplifier or photodetector (e.g., as part of the amplifier implementation at the input port of amplifier), among other example implementations.

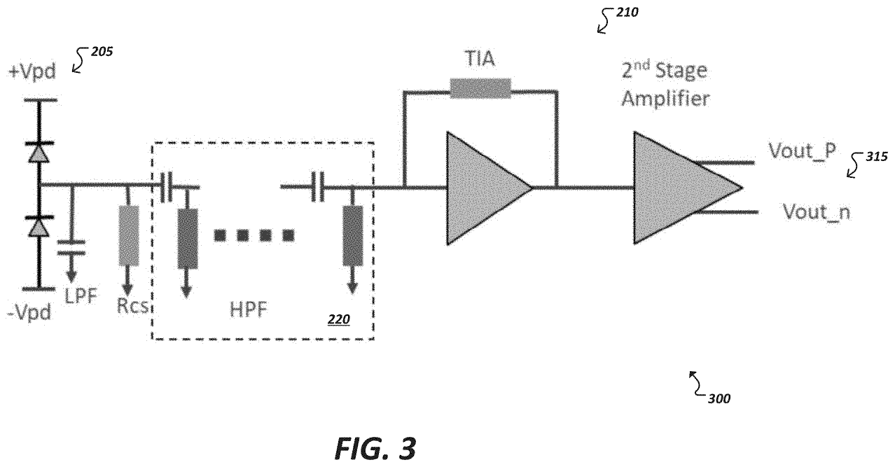

Turning to FIG. 3, a simplified block diagram 300 is shown of an example portion of a Lidar device implemented at least in part using silicon photonics. The device may include photodetector circuitry 205, which may receive light reflected back from the casting of a laser onto various targets of interest. The photodetector 205 may generate an electrical signal corresponding to the received light. The electrical signal generated may be passed to an amplifier block 210 for amplification prior to being passed (e.g., at 315) to additional signal conditioning and eventual processing by additional circuitry (e.g., one or more blocks of processing circuitry). As introduced above, this portion of a Lidar system may be improved through the addition of one or more HPF circuitry blocks (e.g., 220) to remove noise generated by the photodetector 205 based on on-chip OBR emanating from various optical components of the device. In some implementations, a sink current resistor (Rcs) may be provided to sink the DC current for different photo current generated from the balance detectors of the photodetector due to potential imperfections in components of the system such as limited common mode rejection ratio (CMRR), imbalanced dark current of balance photodetectors, etc. A low-pass filter (LPF) may also be provided (e.g., integrated on the PIC or amplifier circuit) and may be formed by Rcs and PD capacitance along with TIA input parasitic/ESD capacitance. The Rcs value may be configured to minimize noise for a given BW requirement of the chain, among other example features.

In the example of FIG. 3, the high pass filter block 220 may reduce the effects of on-chip OBR in that the HPF is tuned to filter frequencies corresponding to reflections at distances outside the operational distances supported by the Lidar device. For instance, the on-chip OBRs may occur at short distances (e.g., <35 mm distance for on-chip or <200 mm for other reflection points) from the photo detector (e.g., photodetector 205). Such filtering can be tuned to also preserve the ability of the Lidar device to support relatively short target ranges (e.g., 0.5 m), there by maintaining corresponding signal response for such close targets within the Lidar sensor's range.

As an illustrative example, an example Lidar system may be configured to support a target range of 0.5 m to 200 m. To address issues with on-chip OBR, a high pass filter block may be provided to operate with the Lidar receiver and remove noise resulting from such on-chip OR. For instance, a high pass filter block may be provided for a PIC with maximum overall path distance of less than 35 mm for on-chip OBR point and/or less than 50 mm for other OBR points away from photo detectors. The minimum target range of 0.5 m has a detected beat frequency of 0.83 MHz for example and maximum range of 200 m has a detected beat frequency of 330 MHz for example with an assumed 0.25 GHz per microsecond chirping rate. The HPF in this example may be configured to have 3 dB low cutoff frequency lower than the beat signal frequency of 0.83 MHz for 0.5 m minimum target range. In this example, the max overall distance of 35 mm of on-chip OBR has a detected beat frequency of 0.13 MHz and/or of 50 mm OBR has a detected beat frequency of 0.19 MHz, as summarized in Tables 1 and 2 below:

TABLE 1
Parameters of Target Ranges

| | Min target | Max target | |
|---|---|---|---|
| | range | range | unit |
| Optical velocity c | 3.00E+08 | 3.00E+08 | m/s |
| Target Range | 0.5 | 200 | m |
| Round trip delay | 3.33E−03 | 1.33E+00 | us |
| FM-CW frequency sweep rate | 0.25 | 0.25 | GHz/us |
| FM-CW Rx detected signal | 0.83 | 333.33 | MHZ |
| frequency | | | |
| FM-CW sweep frequency range | 3.00 | 3.00 | GHz |
| FM-CW detection resolution | 50 | 50 | mm |

TABLE 2
Design example for on-chip optical back reflection (OBRs)

| | Max on- | Max in- | |
|---|---|---|---|
| | chip BR | package BR | unit |
| Optical velocity c | 3.E+08 | 3.E+08 | m/s |
| OBR location | 35 | 50 | mm |
| OBR Delay | 5.37E−04 | 7.67E−04 | us |
| FM-CW chirp rate | 0.25 | 0.25 | GHz/us |
| FM-CW Rx detected beat signal | 0.13 | 0.19 | MHZ |
| Min isolation for BRs with HPF | 20 | 15 | dB |

Given the parameters of the Lidar sensor, its operational frequencies, frequency sweep rate, detection resolution, and target range, one or more HPF blocks may be configured to allow signals generated from useful Lidar reflections (from the targets) to pass the filtering stage to the amplification stage, while removing noise generated from on-chip OBRs. In some implementations, HPF circuitry may include configurable components allowing the HPF to be dynamically configured to change the frequency bands that are filtered (e.g., based on corresponding changes or dynamic configurations of the Lidar device (e.g., supported target ranges), among other example features.

Continuing with the example of FIG. 3 and Tables 1 and 2, an HFP block may be provided, which is configured to have an isolation of 20 dB at the beat frequency of 0.13 MHz for on-chip back reflections and 15 dB at the beat frequency of 0.19 MHz for other optical back reflections. The detected beat signal frequency is proportional to the delay, which is inversely proportional to the group velocity and thus proportional to group index. For instance, the delay for a minimum target range has group index of 1 in air, while the group index of the silicon photonics optical waveguide has typical group index of 4.5. The overall path distance of on-chip OBRs may be the difference of optical path distances between back reflections and a laser as local oscillator (LO) to photodetectors.

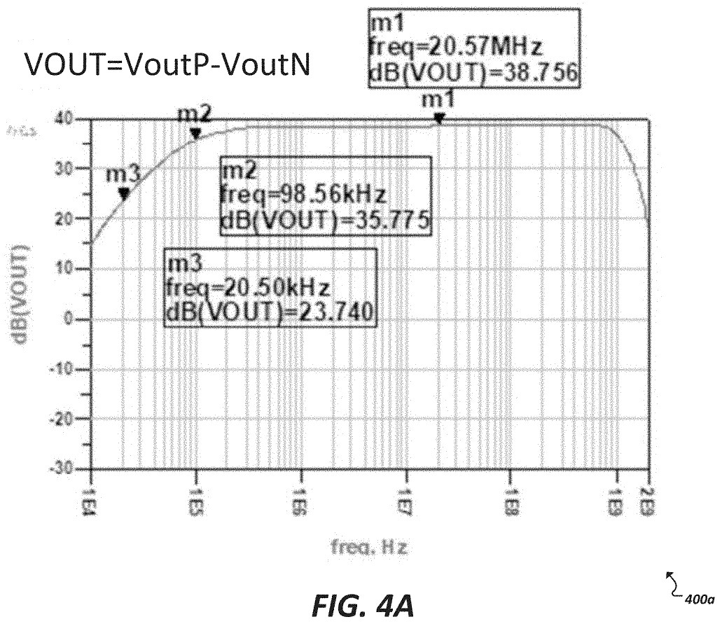

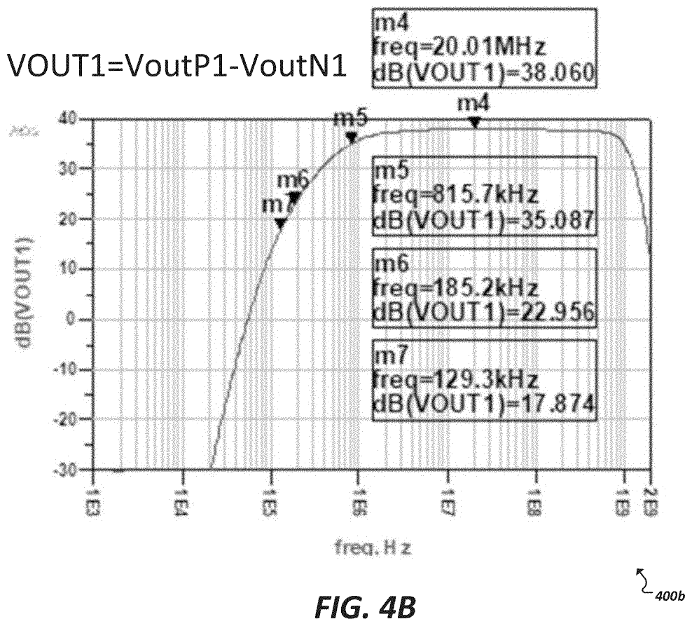

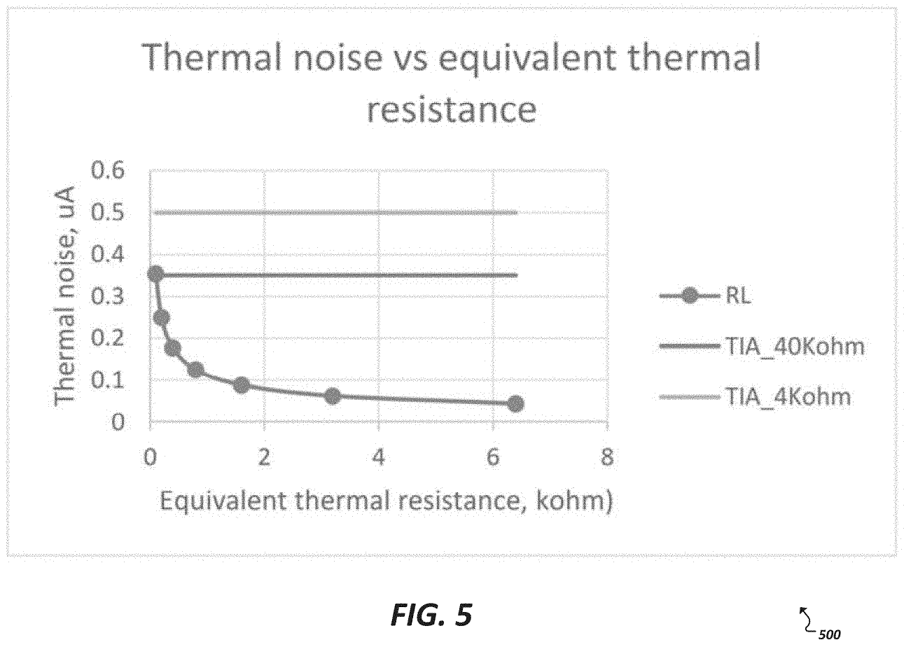

A variety of techniques, components, and configurations may be utilized to implement an example HPF block for use in filtering effects of on-chip OBR on a silicon-implemented Lidar system. For instance, in one example, the HPF block (e.g., 220) may be implemented as a three-stage resistor-capacitor (RC) high pass filter, with the output of the filter provided to an amplifier block (e.g., 210). In one example, a low voltage drop of 20 mV may be provided at the sink current resistor to avoid the impact of photodetector bias with typical 2V. Turning to FIGS. 4A-4B, graphs 400a, 400b are shown illustrating frequency responses of a Lidar receiver in a first device without a high pass filter stage (in FIG. 4A) as compared to that of a Lidar device with a high pass filter stage (in FIG. 4B) as introduced above. For instance, the HPF block can achieve 15 dB isolation at 185 MHz and 20 dB isolation at 129 KHz (as shown in FIG. 4B), comparing the response without HPF which has 2 dB isolation at frequency of 129 KHz (as shown in FIG. 4A). The frequency with HPF has a low frequency cut off at 0.82 MHz, which shows that the beat signal will have less than 3 dB loss at 83 MHz for 0.5 m minimum target range in this example. FIG. 5 shows a graph 500 illustrating the thermal noise due to equivalent resistance from current sink resistor and high pass filter. In some implementations, the HPF block provided between a photodetector and amplifier may be designed to have thermal noise lower than input equivalent noise from the amplifier. In this particular example, the thermal noise of 0.16 uA induced by current sink resistor and HPF 0.16 uA is much lower than typical input equivalent noise from the amplifier block, 0.34 uA and 0.5 uA with 4 Kohm and 40 kohm, respectively, among other example designs and solutions.

In one example implementation, a three-stage RC HPF block positioned between a photodetector and amplifier of an example Lidar device may be implemented with a resistor R=2000 ohm and capacitor C=500 pF. The voltage drop on sink current resistor due to imbalance may be 20 mV at 10 uA sink current, with thermal nose current of 0.16 uA. A loss of less than 3 dB may be achieved for min 0.5 m target range at 0.83 MHz, 20 dB isolation at beat frequency of 0.13 MHz for max distance of 35 mm of on-chip back reflections, and 15 dB isolation at beat frequency of 0.19 MHz for max distance of 50 mm of in-package back reflections.

As noted above HPF circuitry may be provided in a silicon-implemented, coherent Lidar device to mitigate the negative effects of optical back reflections originating from many different areas on the silicon photonics chips, including the output optical facet. For another example, the HPF block can improve signal-to-noise (e.g., by 20 dB) due to on-chip OBR, and thus achieve much better overall Lidar performance, such as wider dynamic operating range, through the elimination of the penalty caused by the on-chip into the balanced photodetector with the similar level of OBRs, compared with conventional coherent Lidar.

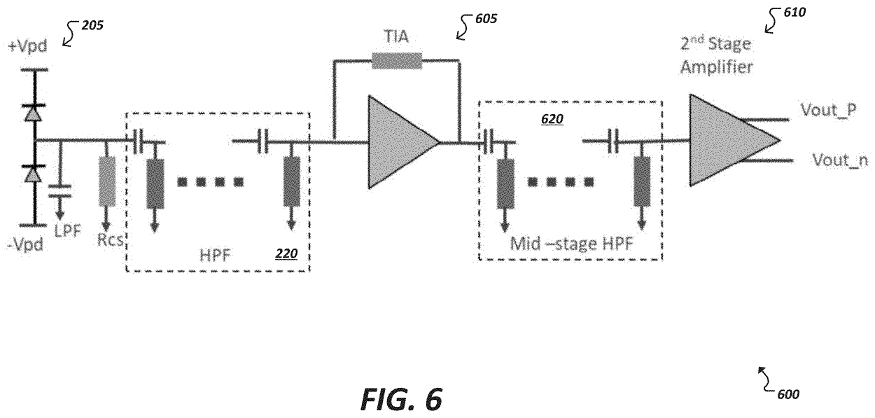

For further reduction of noise due to back reflection, higher orders of high pass filter can be used, which may increase the slope of the filter to eliminate the impact on the minimum target range. To further improve signal-to-noise ratio (SNR) due to back reflections, in some implementations, additional filtering blocks may be introduced within an example Lidar device implemented at least partially using silicon photonics. For instance, in some implementations, a mid-stage high pass filter block may also be provided (in addition to the HPF block preceding the amplifier) following or in the middle of the amplifier block to further improve the signal-to-noise ratio (SNR) due to on-chip back reflections, which can eliminate the saturation of the amplifier block and improve SNR due to back reflection. For instance, FIG. 6 is a simplified block diagram 600 of a portion of circuitry of an example Lidar device. A HPF block 220 may be provided following a photodetector block (e.g., photodetector 205) and preceding an amplifier block 210. In this example, the amplifier block may include circuitry 605 to implement a first amplifier stage and circuitry 610 to implement a second amplifier stage. In this example, an additional mid-stage HPF filter block 620 may be provided between the first and second amplifier stages (e.g., 605, 610).

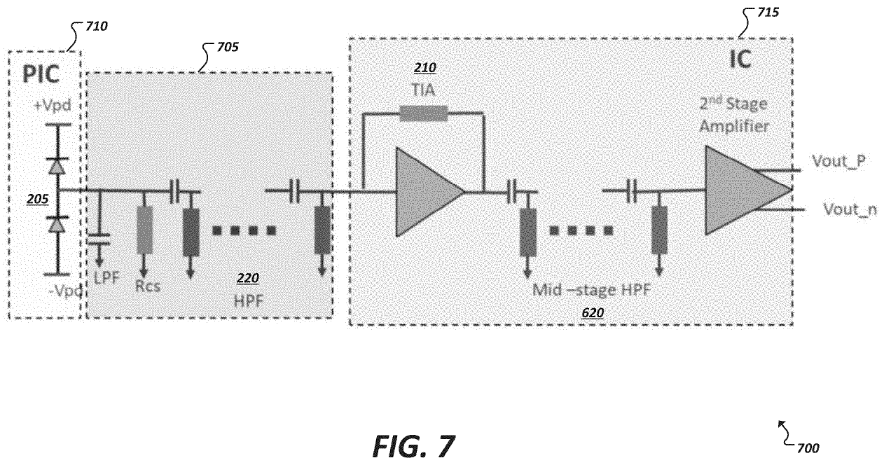

An improved implementation of a coherent Lidar device may apply the solutions and features discussed above in a variety of different embodiments. FIGS. 7-9 show simplified block diagrams 700, 800, 900 illustrating some of the potential implementations of a coherent, silicon photonics Lidar device with one or more HPF blocks to mitigate noise from optical back reflections, including on-chip optical back reflections. For instance, in the example of FIG. 7, an implementation of the solution introduced in the example of FIG. 6 is shown, where the HPF block 220 is implemented on a separate device 705 (e.g., chip, package, die, etc.) from a PIC device (e.g., 710) incorporating the photodetector (e.g., 205). An example PIC device (e.g., 710) may include a laser scanner, laser controller, and photodetector, together with other components of a silicon photonics Lidar device. Additionally, in the example of FIG. 7, amplifier circuitry (e.g., 210) may be provided separate from the HPF device 705, for instance in integrated circuit (IC) device 715. Accordingly, HPF device 705 may be coupled to the PIC device 710 and IC device 715 so as to position HPF block 220 between the output of photodetector 205 and amplifier block 210. In cases where multiple blocks or stages of HPF circuitry (e.g., 220, 620) are provided in a single Lidar system to address OBR, the HPF blocks may all be provided on the same device or alternatively on multiple different devices (e.g., 705, 715), among other example implementations.

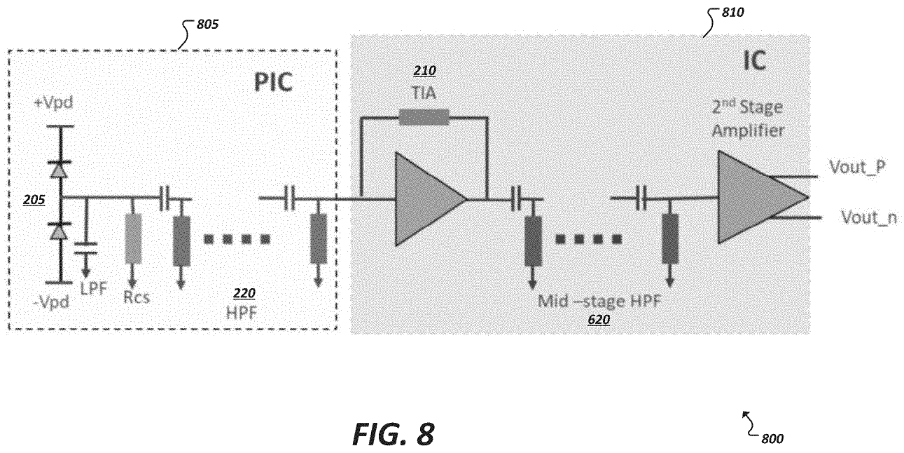

In an alternative implementation, such as shown in FIG. 8, the HPF circuitry 220 may be collocated on a PIC (e.g., 710) or another device implementing the core Lidar functionality (e.g., on the chip, package, die, etc.) within the system. In this example, a PIC device 805 is included which incorporates not only the core Lidar circuitry, including photodetector 205, but also a high pass filter block 220 for filtering on-chip OBR. The enhanced PIC 805 may be communicatively coupled to one or more other chips in the system (e.g., using an interconnect, link, or other communication medium), including an IC 810 including the amplified block 210 among other example circuitry (e.g., a mid-stage HPF block 620). Accordingly, a signal generated by the photodetector 205 and filtered by HPF block 220 may be passed to the IC 810 for further signature conditioning and processing.

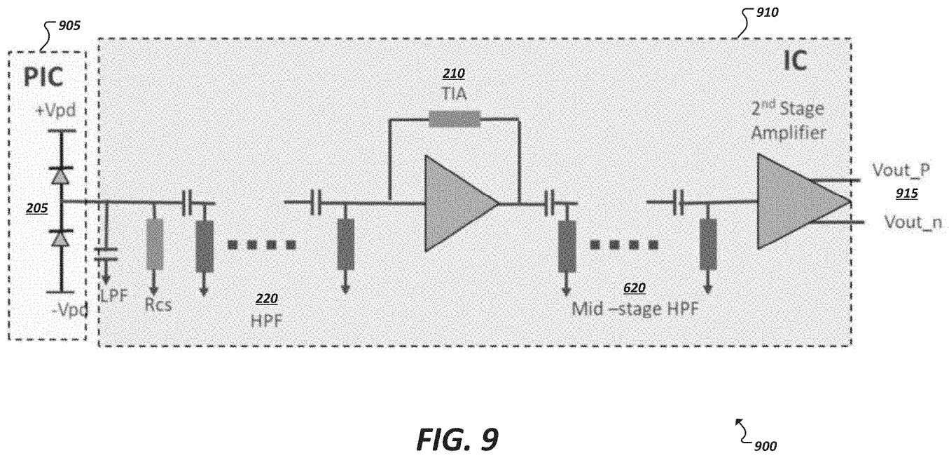

In still another example, shown in FIG. 9, an example HPF block 220 configured for filtering noise from a signal generated by a photodetector on a PIC 905 resulting from optical back reflections in optical components of the PIC 905, may be provided on the same device 910 (e.g., die or package) as the amplifier block 210. The IC 910 may be coupled to the PIC 905 and receive the signal generated by the photodetector 205 (with the OBR noise) over an interface of the IC 910 and PIC 905. In yet another example implementation, both the HPF block 220 and amplifier 210 may be included in the PIC, such as in a Lidar system on chip device, among other example implementations. A filtered and amplified photodetector signal may be passed (e.g., via interface 915) to one or more other compute elements, such as a specialized or general-purpose processor. For instance, the signal may be recorded in data that is to be stored in a memory block to be accessed by software using information captured by the Lidar sensor to perform one or more functions (e.g., in connection with 3D landscape mapping, pathfinding, autonomous navigation (e.g., of a robot or vehicle), among other examples).

Note that the apparatus', methods', and systems described above may be implemented in or cooperate with any electronic device or system as aforementioned. As specific illustrations, the figures below provide exemplary systems for utilizing photodetector data filtered and amplified using the solutions described herein. As the systems below are described in more detail, a number of different devices and architectures are disclosed, described, and revisited from the discussion above.

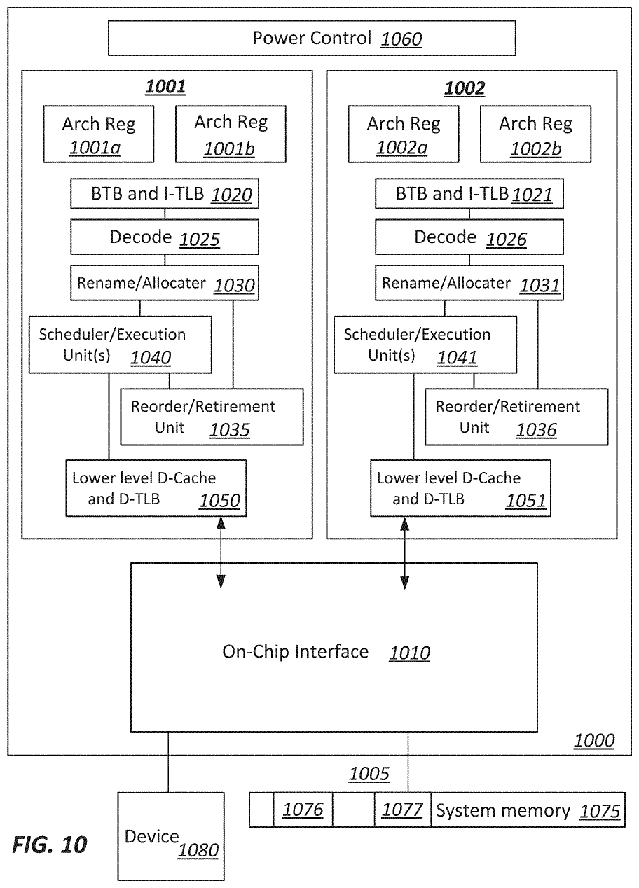

Referring to FIG. 10, an embodiment of a block diagram for a computing system including a multicore processor is depicted. Processor 1000 includes any processor or processing device, such as a microprocessor, an embedded processor, a digital signal processor (DSP), a network processor, a handheld processor, an application processor, a co-processor, a system on a chip (SOC), or other device to execute code. Processor 1000, in one embodiment, includes at least two cores—core 1001 and 1002, which may include asymmetric cores or symmetric cores (the illustrated embodiment). However, processor 1000 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core often refers to logic located on an integrated circuit capable of maintaining an independent architectural state, wherein each independently maintained architectural state is associated with at least some dedicated execution resources. In contrast to cores, a hardware thread typically refers to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical processor 1000, as illustrated in FIG. 10, includes two cores—core 1001 and 1002. Here, core 1001 and 1002 are considered symmetric cores, i.e. cores with the same configurations, functional units, and/or logic. In another embodiment, core 1001 includes an out-of-order processor core, while core 1002 includes an in-order processor core. However, cores 1001 and 1002 may be individually selected from any type of core, such as a native core, a software managed core, a core adapted to execute a native Instruction Set Architecture (ISA), a core adapted to execute a translated Instruction Set Architecture (ISA), a co-designed core, or other known core. In a heterogeneous core environment (i.e. asymmetric cores), some form of translation, such a binary translation, may be utilized to schedule or execute code on one or both cores. Yet to further the discussion, the functional units illustrated in core 1001 are described in further detail below, as the units in core 1002 operate in a similar manner in the depicted embodiment.

As depicted, core 1001 includes two hardware threads 1001a and 1001b, which may also be referred to as hardware thread slots 1001a and 1001b. Therefore, software entities, such as an operating system, in one embodiment potentially view processor 1000 as four separate processors, i.e., four logical processors or processing elements capable of executing four software threads concurrently. As alluded to above, a first thread is associated with architecture state registers 1001a, a second thread is associated with architecture state registers 1001b, a third thread may be associated with architecture state registers 1002a, and a fourth thread may be associated with architecture state registers 1002b. Here, each of the architecture state registers (1001a, 1001b, 1002a, and 1002b) may be referred to as processing elements, thread slots, or thread units, as described above. As illustrated, architecture state registers 1001a are replicated in architecture state registers 1001b, so individual architecture states/contexts are capable of being stored for logical processor 1001a and logical processor 1001b. In core 1001, other smaller resources, such as instruction pointers and renaming logic in allocator and renamer block 1030 may also be replicated for threads 1001a and 1001b. Some resources, such as re-order buffers in reorder/retirement unit 1035, ILTB 1020, load/store buffers, and queues may be shared through partitioning. Other resources, such as general purpose internal registers, page-table base register(s), low-level data-cache and data-TLB 1015, execution unit(s) 1040, and portions of out-of-order unit 1035 are potentially fully shared.

Processor 1000 often includes other resources, which may be fully shared, shared through partitioning, or dedicated by/to processing elements. In FIG. 10, an embodiment of a purely exemplary processor with illustrative logical units/resources of a processor is illustrated. Note that a processor may include, or omit, any of these functional units, as well as include any other known functional units, logic, or firmware not depicted. As illustrated, core 1001 includes a simplified, representative out-of-order (OOO) processor core. But an in-order processor may be utilized in different embodiments. The OOO core includes a branch target buffer 1020 to predict branches to be executed/taken and an instruction-translation buffer (I-TLB) 1020 to store address translation entries for instructions.

Core 1001 further includes decode module 1025 coupled to fetch unit 1020 to decode fetched elements. Fetch logic, in one embodiment, includes individual sequencers associated with thread slots 1001a, 1001b, respectively. Usually core 1001 is associated with a first ISA, which defines/specifies instructions executable on processor 1000. Often machine code instructions that are part of the first ISA include a portion of the instruction (referred to as an opcode), which references/specifies an instruction or operation to be performed. Decode logic 1025 includes circuitry that recognizes these instructions from their opcodes and passes the decoded instructions on in the pipeline for processing as defined by the first ISA. For example, as discussed in more detail below decoders 1025, in one embodiment, include logic designed or adapted to recognize specific instructions, such as transactional instruction. As a result of the recognition by decoders 1025, the architecture or core 1001 takes specific, predefined actions to perform tasks associated with the appropriate instruction. It is important to note that any of the tasks, blocks, operations, and methods described herein may be performed in response to a single or multiple instructions; some of which may be new or old instructions. Note decoders 1026, in one embodiment, recognize the same ISA (or a subset thereof). Alternatively, in a heterogeneous core environment, decoders 1026 recognize a second ISA (either a subset of the first ISA or a distinct ISA).

In one example, allocator and renamer block 1030 includes an allocator to reserve resources, such as register files to store instruction processing results. However, threads 1001a and 1001b are potentially capable of out-of-order execution, where allocator and renamer block 1030 also reserves other resources, such as reorder buffers to track instruction results. Unit 1030 may also include a register renamer to rename program/instruction reference registers to other registers internal to processor 1000. Reorder/retirement unit 1035 includes components, such as the reorder buffers mentioned above, load buffers, and store buffers, to support out-of-order execution and later in-order retirement of instructions executed out-of-order.

Scheduler and execution unit(s) block 1040, in one embodiment, includes a scheduler unit to schedule instructions/operation on execution units. For example, a floating point instruction is scheduled on a port of an execution unit that has an available floating point execution unit. Register files associated with the execution units are also included to store information instruction processing results. Exemplary execution units include a floating point execution unit, an integer execution unit, a jump execution unit, a load execution unit, a store execution unit, and other known execution units.

Lower level data cache and data translation buffer (D-TLB) 1050 are coupled to execution unit(s) 1040. The data cache is to store recently used/operated on elements, such as data operands, which are potentially held in memory coherency states. The D-TLB is to store recent virtual/linear to physical address translations. As a specific example, a processor may include a page table structure to break physical memory into a plurality of virtual pages.

Here, cores 1001 and 1002 share access to higher-level or further-out cache, such as a second level cache associated with on-chip interface 1010. Note that higher-level or further-out refers to cache levels increasing or getting further way from the execution unit(s). In one embodiment, higher-level cache is a last-level data cache—last cache in the memory hierarchy on processor 1000—such as a second or third level data cache. However, higher level cache is not so limited, as it may be associated with or include an instruction cache. A trace cache—a type of instruction cache—instead may be coupled after decoder 1025 to store recently decoded traces. Here, an instruction potentially refers to a macro-instruction (i.e. a general instruction recognized by the decoders), which may decode into a number of micro-instructions (micro-operations).

In the depicted configuration, processor 1000 also includes on-chip interface module 1010. Historically, a memory controller, which is described in more detail below, has been included in a computing system external to processor 1000. In this scenario, on-chip interface 1010 is to communicate with devices external to processor 1000, such as system memory 1075, a chipset (often including a memory controller hub to connect to memory 1075 and an I/O controller hub to connect peripheral devices), a memory controller hub, a northbridge, or other integrated circuit. And in this scenario, bus 1005 may include any known interconnect, such as multi-drop bus, a point-to-point interconnect, a serial interconnect, a parallel bus, a coherent (e.g. cache coherent) bus, a layered protocol architecture, a differential bus, and a GTL bus.

Memory 1075 may be dedicated to processor 1000 or shared with other devices in a system. Common examples of types of memory 1075 include DRAM, SRAM, non-volatile memory (NV memory), and other known storage devices. Note that device 1080 may include a graphic accelerator, processor or card coupled to a memory controller hub, data storage coupled to an I/O controller hub, a wireless transceiver, a flash device, an audio controller, a network controller, or other known device.

Recently however, as more logic and devices are being integrated on a single die, such as SOC, each of these devices may be incorporated on processor 1000. For example in one embodiment, a memory controller hub is on the same package and/or die with processor 1000. Here, a portion of the core (an on-core portion) 1010 includes one or more controller(s) for interfacing with other devices such as memory 1075 or a graphics device 1080. The configuration including an interconnect and controllers for interfacing with such devices is often referred to as an on-core (or un-core configuration). As an example, on-chip interface 1010 includes a ring interconnect for on-chip communication and a high-speed serial point-to-point link 1005 for off-chip communication. Yet, in the SOC environment, even more devices, such as the network interface, co-processors, memory 1075, graphics processor 1080, and any other known computer devices/interface may be integrated on a single die or integrated circuit to provide small form factor with high functionality and low power consumption.

In one embodiment, processor 1000 is capable of executing a compiler, optimization, and/or translator code 1077 to compile, translate, and/or optimize application code 1076 to support the apparatus and methods described herein or to interface therewith. A compiler often includes a program or set of programs to translate source text/code into target text/code. Usually, compilation of program/application code with a compiler is done in multiple phases and passes to transform hi-level programming language code into low-level machine or assembly language code. Yet, single pass compilers may still be utilized for simple compilation. A compiler may utilize any known compilation techniques and perform any known compiler operations, such as lexical analysis, preprocessing, parsing, semantic analysis, code generation, code transformation, and code optimization.

Larger compilers often include multiple phases, but most often these phases are included within two general phases: (1) a front-end, i.e. generally where syntactic processing, semantic processing, and some transformation/optimization may take place, and (2) a back-end, i.e. generally where analysis, transformations, optimizations, and code generation takes place. Some compilers refer to a middle, which illustrates the blurring of delineation between a front-end and back end of a compiler. As a result, reference to insertion, association, generation, or other operation of a compiler may take place in any of the aforementioned phases or passes, as well as any other known phases or passes of a compiler. As an illustrative example, a compiler potentially inserts operations, calls, functions, etc. in one or more phases of compilation, such as insertion of calls/operations in a front-end phase of compilation and then transformation of the calls/operations into lower-level code during a transformation phase. Note that during dynamic compilation, compiler code or dynamic optimization code may insert such operations/calls, as well as optimize the code for execution during runtime. As a specific illustrative example, binary code (already compiled code) may be dynamically optimized during runtime. Here, the program code may include the dynamic optimization code, the binary code, or a combination thereof.

Similar to a compiler, a translator, such as a binary translator, translates code either statically or dynamically to optimize and/or translate code. Therefore, reference to execution of code, application code, program code, or other software environment may refer to: (1) execution of a compiler program(s), optimization code optimizer, or translator either dynamically or statically, to compile program code, to maintain software structures, to perform other operations, to optimize code, or to translate code; (2) execution of main program code including operations/calls, such as application code that has been optimized/compiled; (3) execution of other program code, such as libraries, associated with the main program code to maintain software structures, to perform other software related operations, or to optimize code; or (4) a combination thereof.

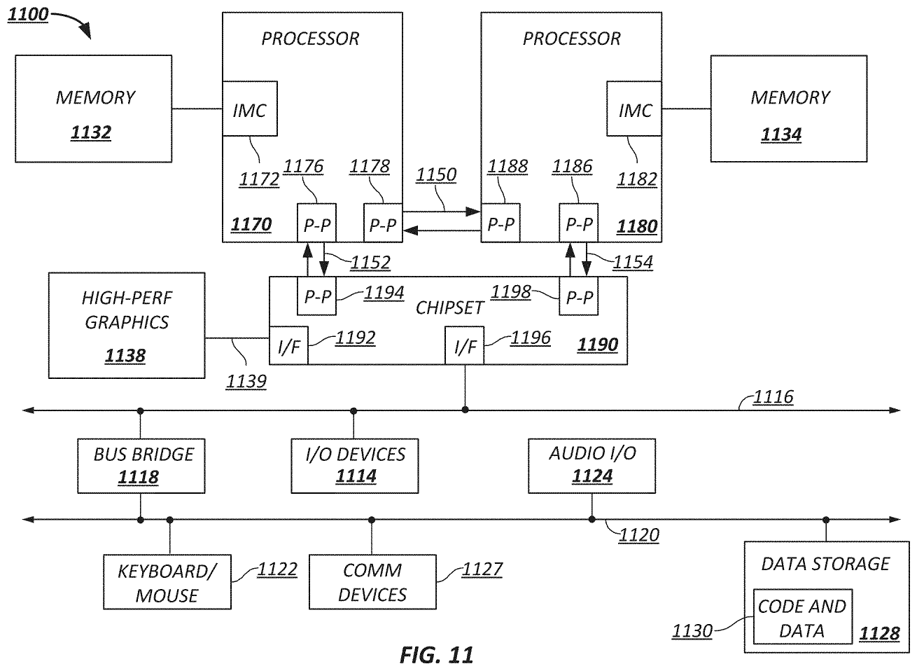

Referring now to FIG. 11, shown is a block diagram of a second system 1100 in accordance with an embodiment of the present disclosure. As shown in FIG. 11, multiprocessor system 1100 is a point-to-point interconnect system, and includes a first processor 1170 and a second processor 1180 coupled via a point-to-point interconnect 1150. Each of processors 1170 and 1180 may be some version of a processor. In one embodiment, 1152 and 1154 are part of a serial, point-to-point coherent interconnect fabric, such as a high-performance architecture. As a result, the solutions described herein may be implemented within a UPI or other architecture.

While shown with only two processors 1170, 1180, it is to be understood that the scope of the present disclosure is not so limited. In other embodiments, one or more additional processors may be present in a given processor.

Processors 1170 and 1180 are shown including integrated memory controller units 1172 and 1182, respectively. Processor 1170 also includes as part of its bus controller units point-to-point (P-P) interfaces 1176 and 1178; similarly, second processor 1180 includes P-P interfaces 1186 and 1188. Processors 1170, 1180 may exchange information via a point-to-point (P-P) interface 1150 using P-P interface circuits 1178, 1188. As shown in FIG. 11, IMCs 1172 and 1182 couple the processors to respective memories, namely a memory 1132 and a memory 1134, which may be portions of main memory locally attached to the respective processors.

Processors 1170, 1180 each exchange information with a chipset 1190 via individual P-P interfaces 1152, 1154 using point to point interface circuits 1176, 1194, 1186, 1198. Chipset 1190 also exchanges information with a high-performance graphics circuit 1138 via an interface circuit 1192 along a high-performance graphics interconnect 1139.

A shared cache (not shown) may be included in either processor or outside of both processors; yet connected with the processors via P-P interconnect, such that either or both processors' local cache information may be stored in the shared cache if a processor is placed into a low power mode.

Chipset 1190 may be coupled to a first bus 1116 via an interface 1196. In one embodiment, first bus 1116 may be a Peripheral Component Interconnect (PCI) bus, or a bus such as a PCI Express bus or another third generation I/O interconnect bus, although the scope of the present disclosure is not so limited.

As shown in FIG. 11, various I/O devices 1114 are coupled to first bus 1116, along with a bus bridge 1118 which couples first bus 1116 to a second bus 1120. In one embodiment, second bus 1120 includes a low pin count (LPC) bus. Various devices are coupled to second bus 1120 including, for example, a keyboard and/or mouse 1122, communication devices 1127 and a storage unit 1128 such as a disk drive or other mass storage device which often includes instructions/code and data 1130, in one embodiment. Further, an audio I/O 1124 is shown coupled to second bus 1120. Note that other architectures are possible, where the included components and interconnect architectures vary. For example, instead of the point-to-point architecture of FIG. 11, a system may implement a multi-drop bus or other such architecture.

While the solutions discussed herein have been described with respect to a limited number of embodiments, those skilled in the art will appreciate numerous modifications and variations therefrom. It is intended that the appended claims cover all such modifications and variations as fall within the true spirit and scope of this disclosure.

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosures.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘to,’ ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform example embodiments herein may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

The following examples pertain to embodiments in accordance with this Specification. Example 1 is an apparatus including: high-pass filter circuitry to: receive a signal from a photodetector of a lidar sensor device; and attenuate a lower frequency portion of the signal, where the lower frequency portion of the signal is generated based on optical back reflections within the lidar sensor device.

Example 2 includes the subject matter of example 1, where the high-pass filter circuitry is configured to allow another higher-frequency portion of the signal to pass, where the other higher-frequency portion of the signal corresponds to light reflected from an object targeted by the lidar sensor device.

Example 3 includes the subject matter of example 2, where the high-pass filter circuitry is configured to maintain a cut-off frequency based on a range of distances of the lidar sensor device.

Example 4 includes the subject matter of example 3, where the high-pass filter circuitry includes configurable circuitry elements to modify the cut-off frequency based on a change in the range of distances of the lidar sensor device.

Example 5 includes the subject matter of any one of examples 2-4, where the high-pass filter circuitry includes a three-stage resistor-capacitor (RC) filter.

Example 6 includes the subject matter of any one of examples 2-5, where the high-pass filter circuitry outputs a filtered version of the signal to amplifier circuitry.

Example 7 includes the subject matter of example 6, where the amplifier circuitry is to output an amplified version of the filtered signal to a processor device.

Example 8 includes the subject matter of any one of examples 6-7, where the high-pass filter circuitry includes a first high pass filter and the apparatus further includes a second high pass filter to filter an output of the amplifier circuitry to further attenuate the lower frequency portion of the signal.

Example 9 includes the subject matter of any one of examples 1-8, where the lidar sensor device includes a photonic integrated circuit (PIC) to implement at least the photodetector, an emitter, and a controller of the lidar device, and the optical back reflections include on-chip optical back reflections from optical components of the PIC.

Example 10 includes the subject matter of example 9, where the high-pass filter circuitry is on a same die as the PIC.

Example 11 includes the subject matter of example 9, where the high-pass filter circuitry is on a same package as the PIC.

Example 12 includes the subject matter of example 9, where the high-pass filter circuitry is on a different die or package as the PIC and is coupled to the PIC by an interface to receive the signal from the PIC.

Example 13 includes the subject matter of any one of examples 1-12, where the lidar device includes a coherent lidar device.

Example 14 is a method including: receiving, at a high-pass filter circuitry block, a signal generated by a photodetector of a lidar device, where the lidar device is configured to detect objects within a range of distances; attenuating a first portion of the signal below a cutoff frequency using the high-pass filter circuitry block, where the first portion of the signal includes frequencies corresponding to optical back reflections present on the lidar device; and passing a second portion of the signal above the cutoff frequency using the high-pass filter circuitry block, where the second portion of the signal corresponds to light detected by the photodetector as reflected back to the lidar device from a target object.

Example 15 includes the subject matter of example 14, further including amplifying the second portion of the signal as output from the high-pass filter circuitry block.

Example 16 includes the subject matter of example 15, further including outputting the amplified second portion of the signal to a processor device.

Example 17 includes the subject matter of example 16, where the processor device uses the amplified second portion of the signal in an autonomous navigation application for one of a vehicle, drone, or robot.

Example 18 includes the subject matter of any one of examples 15-17, further including outputting the amplified second portion of the signal to a second high-pass filter circuitry block for further attenuating of the first portion of the signal.

Example 19 includes the subject matter of any one of examples 14-18, where the high-pass filter circuitry block is configured to maintain the cut-off frequency based on a range of distances of the lidar sensor device.

Example 20 includes the subject matter of any one of examples 14-19, where the high-pass filter circuitry block includes configurable circuitry elements to modify the cut-off frequency based on a change in the range of distances of the lidar sensor device.

Example 21 includes the subject matter of example 20, further including modifying the configurable circuitry elements of the high-pass filter circuitry block to change the cut-off frequency.

Example 22 includes the subject matter of any one of examples 14-21, where the high-pass filter circuitry block includes a three-stage resistor-capacitor (RC) filter.

Example 23 includes the subject matter of any one of examples 14-22, where the lidar device includes a photonic integrated circuit (PIC) to implement at least the photodetector, an emitter, and a controller of the lidar device, and the optical back reflections include on-chip optical back reflections from optical components of the PIC.

Example 24 includes the subject matter of example 23, where the high-pass filter circuitry block is on a same die as the PIC.

Example 25 includes the subject matter of example 23, where the high-pass filter circuitry block is on a same package as the PIC.

Example 26 includes the subject matter of example 23, where the high-pass filter circuitry block is on a different die or package as the PIC and is coupled to the PIC by an interface to receive the signal from the PIC.

Example 27 includes the subject matter of any one of examples 14-26, where the lidar device includes a coherent lidar device.

Example 28 is a system including means to perform the method of any one of examples 14-27.

Example 29 is a system including: a lidar sensor chip including: a laser; a photodetector; and one or more waveguides; high-pass filter circuitry to filter an output of the photodetector to remove noise associated with on-chip optical back reflections within the lidar sensor chip and generate a filtered version of the output; and amplifier circuitry to amplify the filtered version of the output.

Example 30 includes the subject matter of example 29, where the lidar sensor chip includes a photonic integrated chip and the laser is implemented using silicon photonics.

Example 31 includes the subject matter of any one of examples 29-30, further including: second high-pass filter circuitry to further filter an amplified output of the amplifier circuitry to remove noise associated with the on-chip optical back reflections; and second amplifier circuitry to amplify an output of the second high-pass filter circuitry.

Example 32 includes the subject matter of any one of examples 29-31, further including a processor to process the filtered version of the output.

Example 33 includes the subject matter of any one of examples 29-32, where the high-pass filter circuitry is included on a same package with the lidar sensor chip or the amplifier circuitry.

Example 34 includes the subject matter of any one of examples 29-33, where the high-pass filter circuitry is configured to maintain a cut-off frequency based on a range of distances measurable by the lidar sensor chip.

Example 35 includes the subject matter of example 34, where the high-pass filter circuitry includes configurable circuitry elements to modify the cut-off frequency based on a change in the range of distances of the lidar sensor chip.

Example 36 includes the subject matter of any one of examples 29-35, where the high-pass filter circuitry includes a three-stage resistor-capacitor (RC) filter.

Example 37 includes the subject matter of any one of examples 29-36, further including a second high pass filter to filter an output of the amplifier circuitry to further remove noise associated with on-chip optical back reflections.

Example 38 includes the subject matter of any one of examples 29-37, where frequencies of the on-chip optical back reflections are filtered out by the high-pass filter circuitry.

Example 39 includes the subject matter of any one of examples 29-38, further including a controller to use the filtered version of the output to determine navigation of a machine.

Example 40 includes the subject matter of example 39, where the controller is to cause the machine to autonomously navigate an environment based on the filtered version of the output

Example 41 includes the subject matter of example 40, where the machine includes one of a vehicle, drone, or robot.

Example 42 includes the subject matter of any one of examples 39-41, where the system includes the machine.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the invention as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. An apparatus comprising:
high-pass filter circuitry to:
receive a signal from a photodetector of a lidar sensor device; and
attenuate a lower frequency portion of the signal, wherein the lower frequency portion of the signal is generated based on optical back reflections within the lidar sensor device.

2. The apparatus of claim 1, wherein the high-pass filter circuitry is configured to allow another higher-frequency portion of the signal to pass, wherein the other higher-frequency portion of the signal corresponds to light reflected from an object targeted by the lidar sensor device.

3. The apparatus of claim 2, wherein the high-pass filter circuitry is configured to maintain a cut-off frequency based on a range of distances of the lidar sensor device.

4. The apparatus of claim 3, wherein the high-pass filter circuitry comprises configurable circuitry elements to modify the cut-off frequency based on a change in the range of distances of the lidar sensor device.

5. The apparatus of claim 2, wherein the high-pass filter circuitry comprises a three-stage resistor-capacitor (RC) filter.

6. The apparatus of claim 2, wherein the high-pass filter circuitry outputs a filtered version of the signal to amplifier circuitry.

7. The apparatus of claim 6, wherein the amplifier circuitry is to output an amplified version of the filtered signal to a processor device.

8. The apparatus of claim 6, wherein the high-pass filter circuitry comprises a first high pass filter and the apparatus further comprises a second high pass filter to filter an output of the amplifier circuitry to further attenuate the lower frequency portion of the signal.

9. The apparatus of claim 1, wherein the lidar sensor device comprises a photonic integrated circuit (PIC) to implement at least the photodetector, an emitter, and a controller of the lidar device, and the optical back reflections comprise on-chip optical back reflections from optical components of the PIC.

10. The apparatus of claim 9, wherein the high-pass filter circuitry is on a same die as the PIC.

11. The apparatus of claim 9, wherein the high-pass filter circuitry is on a same package as the PIC.

12. The apparatus of claim 9, wherein the high-pass filter circuitry is on a different die or package as the PIC and is coupled to the PIC by an interface to receive the signal from the PIC.

13. The apparatus of claim 1, wherein the lidar device comprises a coherent lidar device.

14. A method comprising:
receiving, at a high-pass filter circuitry block, a signal generated by a photodetector of a lidar device, wherein the lidar device is configured to detect objects within a range of distances;
attenuating a first portion of the signal below a cutoff frequency using the high-pass filter circuitry block, wherein the first portion of the signal comprises frequencies corresponding to optical back reflections present on the lidar device; and
passing a second portion of the signal above the cutoff frequency using the high-pass filter circuitry block, wherein the second portion of the signal corresponds to light detected by the photodetector as reflected back to the lidar device from a target object.

15. The method of claim 14, further comprising amplifying the second portion of the signal as output from the high-pass filter circuitry block.

16. A system comprising:
a lidar sensor chip comprising:
a laser;
a photodetector; and
one or more waveguides;
high-pass filter circuitry to filter an output of the photodetector to remove noise associated with on-chip optical back reflections within the lidar sensor chip and generate a filtered version of the output; and
amplifier circuitry to amplify the filtered version of the output.

17. The system of claim 16, wherein the lidar sensor chip comprises a photonic integrated chip and the laser is implemented using silicon photonics.

18. The system of claim 16, further comprising:
second high-pass filter circuitry to further filter an amplified output of the amplifier circuitry to remove noise associated with the on-chip optical back reflections; and
second amplifier circuitry to amplify an output of the second high-pass filter circuitry.

19. The system of claim 16, further comprising a processor to process the filtered version of the output.

20. The system of claim 16, wherein the high-pass filter circuitry is included on a same package with the lidar sensor chip or the amplifier circuitry.
